(19) United States
(12) Patent Application Publication
(10) Pub. No.: US 2012/0188369 A1
(43) Pub. Date: Jul. 26, 2012

(54) Astronomy Camera with Real Time Image Viewing and Method of Use

(76) Inventor: Jason Griesbach, Richfield, WI (US)

(21) Appl. No.: 13/012,576

(22) Filed: Jan. 24, 2011

(51) Int. Cl. H04N 5/225; H04N 7/18

(52) U.S. Cl. 348/143; 348/207.1; 348/E07.085; 348/E05.024

(57) ABSTRACT

An astronomy camera with a CMOS detector with non-destructive read capability displays images of a scene being captured as the image is exposed. The apparatus has a detector with non-destructive read capability which allows data to be read out without resetting the detector to provide a user with updated images as the image is being exposed. This enables users to save the images at various states of the exposure and to end the exposure at will.

### FIELD OF INVENTION

The present invention relates to the field of astronomy, and specifically to an astronomy camera with real time image view.

### BRIEF DESCRIPTION OF THE DRAWINGS

FIG. 1 illustrates the exterior of an exemplary embodiment of an astronomy camera with real time image viewing.

FIG. 2 is an exploded view of an exemplary embodiment of an astronomy camera with real time image viewing.

FIG. 3 is an exemplary embodiment of the interior of an assembled astronomy camera with real time image viewing.

FIG. 4 illustrates an exemplary embodiment an astronomy camera with real time image viewing in use with a telescope and remote viewing device.

FIG. 5 is an exemplary embodiment of an astronomy camera with real time image viewing in use with viewing glasses.

FIG. 6 illustrates an exemplary embodiment of an astronomy camera with real time image viewing adapted to communicate wirelessly with a remote viewing device.

FIG. 7 illustrates an exemplary embodiment of an astronomy camera with real time image viewing adapted to communicate wirelessly with a mobile device.

FIG. 8 is a flow chart illustrating exemplary processing steps used by an astronomy camera with real time viewing to provide a user with an updated image as it is being integrated and allow a user to optionally end an exposure.

### GLOSSARY

As used herein, the term “analog-digital converter” or “ND converter” refers to any device known in the art to convert an analog signal into a digital signal.

As used herein, the term “buffer” refers to a device used to transfer a voltage from a first circuit, having a high output impedance level, to a second circuit with a low input impedance level. A buffer may include more than two circuits.

As used herein, the term “exposure” refers to the time during which an image is developed.

As used herein, the term “filter mounting device” refers to a structure that allows removal or substitution of filters or rotation between multiple filters.

As used herein, the term “image data processor” refers to a microprocessor, microcontroller, or programmable hardware that is capable of receiving data from an optical array detector and performing processing functions in furtherance of creating or displaying one or more astronomy images.

As used herein, the term “non-destructive read” refers to a process/capability that allows an optical array detector to be read out as an image is being exposed without substantially removing some or all of the charge from the image sensor as the image is being displayed by any means known in the art.

As used herein, the term “optical array detector” refers to any device comprised of a plurality of light sensing elements which convert light into an electrical signal. Light sensing elements may include, but are not limited to, photodiodes, photodetectors, MOS capacitors, phototransistors, or any other functionally equivalent structure or device known in the art to detect light and convert it into a current, charge or voltage value. Charge coupled devices, CMOS image sensors, and contact image sensors are types of optical array detectors.

As used herein, the term “readout” means the process of retrieving data from an optical detector. The readout process may be destructive or non-destructive. A destructive read out process reads data and resets a signal in the same operation. A non-destructive read process reads data without resetting the signal.

As used herein, the term “real time” means a time that is less than a single viewing session.

As used herein, the term “thermoelectric cooler” refers to any structure or device which creates a heat flux between two different materials by transferring heat from one material to another against the temperature gradient with the consumption of electrical energy.

As used herein, the term “viewing session” refers to time waiting for an image to sufficiently expose.

### BACKGROUND

Astronomy is a hobby that is quickly gaining popularity; however, few get into astronomy due to the complexity of equipment. In order to capture images with the color and detail sought by amateurs, professionals, publications and other entities, exposure times up to one hour may be necessary. Few people have patience or expertise to have pictures turn out.

Most astronomy cameras use a charge coupled device (CCD) image sensor. When a picture is taken using a camera with a CCD image sensor, the image cannot be viewed until after the exposure is complete. This is a consequence of the way images are developed using CCD image sensors. The CCD optical array detector converts light to charge, which is stored in discrete physical regions called pixels. That charge is electrically coupled to a gate structure. The voltage on the gate is manipulated to move the charge off of the array for readout. Thus the readout of a pixel cannot occur without first removing the charge from that pixel. This type of readout that removes charge from the image sensor is called destructive readout.

A CMOS image sensor is an optical array detector in which each light sensing element is coupled with a buffer such as a transistor. Most CMOS arrays used in consumer applications are designed for destructive readout. However, a few CMOS image sensors are capable of performing a readout in a non-destructive manner. Such image sensors with non-destructive read function are sometimes used in professional astronomy instrumentation to lower noise, but they are not used in conjunction with a live (real time) read out.

As a result, users cannot view an image during exposure; no live feedback is provided, any screen coupled to the camera is typically blank, and timed exposures cannot be stopped early without stopping exposure.

Astronomy cameras known in the art using a CCD also have limited opportunity for user interaction. A user sets an exposure time, waits during the exposure time, during which no real time viewing or preview image can be generated, and then finally receives a final image as the detector is read and necessarily reset.

There are many problems with having a blank screen during capture and using a detector that is necessarily reset as an image is read out. First, it is not possible to tell whether a resulting image will turn out over- or under-exposed. It may be desirable to end a capture early if the image is exposed sooner than expected, but, with a blank screen, users cannot determine whether an image is properly exposed. Similarly, images may end up under-exposed if the exposure time is not long enough.

The camera may also lose its tracking. As the Earth rotates, stars and other astronomical bodies move across the sky. With potential exposure times up to an hour, it is necessary for the camera to follow, or track, the desired image for capture. Without being able to view an image as it develops, the tracking may be slightly off and a user would never know until the final image. Telescopes may also be bumped, tipped or blown slightly off track without a user knowing it. As a result, images may be blurred or capture images other than what was desired.

It is also possible for peripheral light, such as airplanes, flashlights, car lights or other distant light sources, to disrupt an image capture. These unwanted lights can cause spots or streaks in resulting images, or even over-expose the entire image. Without being able to view an image as it develops, it is not possible to tell what effect, if any, peripheral light may have on a final image.

Clouds may also interfere with astrophotography. While it may be possible to watch the night sky to make sure a cloud is not passing through the field of view trying to be captured, when exposure times reach toward one hour, it is not practical or desirable to sit and watch a single patch of sky. Even within the span of a few seconds, a cloud may cross the field of view and ruin an exposure. Without being able to watch an image as it develops, however, a user will not know a cloud destroyed the image until it is completed.

As a result of the lack of feedback during long exposure times, it is estimated that only one in every five pictures taken turns out, and countless hours spent on the remaining four pictures are lost.

Astronomy cameras known in the art are not capable of displaying image data that consumers can view while an image is being exposed. Cameras known in the art are designed to produce a single readout after exposure is complete.

A consumer attempting to use an astronomy camera known in the art would be required to watch a blank image screen for up to an hour as the image sensor accumulates charge in preparation for final readout. This makes a viewing session tedious and un-instructive.

It is desirable to have an astronomy camera capable of displaying images to an amateur photographer while an images is being exposed, so that the user is can watch an actual, continuously updated image and enjoy a productive viewing session.

It is desirable to design an astronomy camera capable of providing real time feedback as an image is being exposed.

It is further desirable to design an astronomy camera capable of providing real time feedback as an image is being exposed that is user friendly and priced for the amateur astronomer.

It is further desirable to design an astronomy camera capable of auto-saving an image as it develops to prevent loss of an entire image.

### SUMMARY OF THE INVENTION

The present invention is an astronomy camera apparatus which provides a real time display of an astronomy image capable of being viewed by a user continuously as an image is being exposed. The apparatus includes a housing containing an optical focusing element situated over an aperture to focus an image on a detector. The detector contains an array of non-destructive read light sensitive elements comprised of a light sensitive component and a buffer component so that the light sensing elements can read aquired photocharge in a non-destructive manner and without resetting. In various embodiments, a thermoelectric cooler keeps the detector cool during long exposures. An analog-digital converter is operatively coupled to each light sensing element to transmit a digital representation of the data collected by the light sensing elements to a processor for display on a user interface.

Because the photocharge stored on the light sensitive elements can be read without resetting the charge value, the detector can be continuously re-read during an exposure and an image may be viewed on a user interface as the image is integrating. Users are able to end exposure at a desired time based on the feedback provided by a real time view of the image during exposure.

### DETAILED DESCRIPTION OF INVENTION

For the purpose of promoting an understanding of the present invention, references are made in the text to exemplary embodiments of an astronomy camera with real time image viewing, only some of which are described herein. It should be understood that no limitations on the scope of the invention are intended by describing these exemplary embodiments. One of ordinary skill in the art will readily appreciate that alternate but functionally equivalent structures and components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

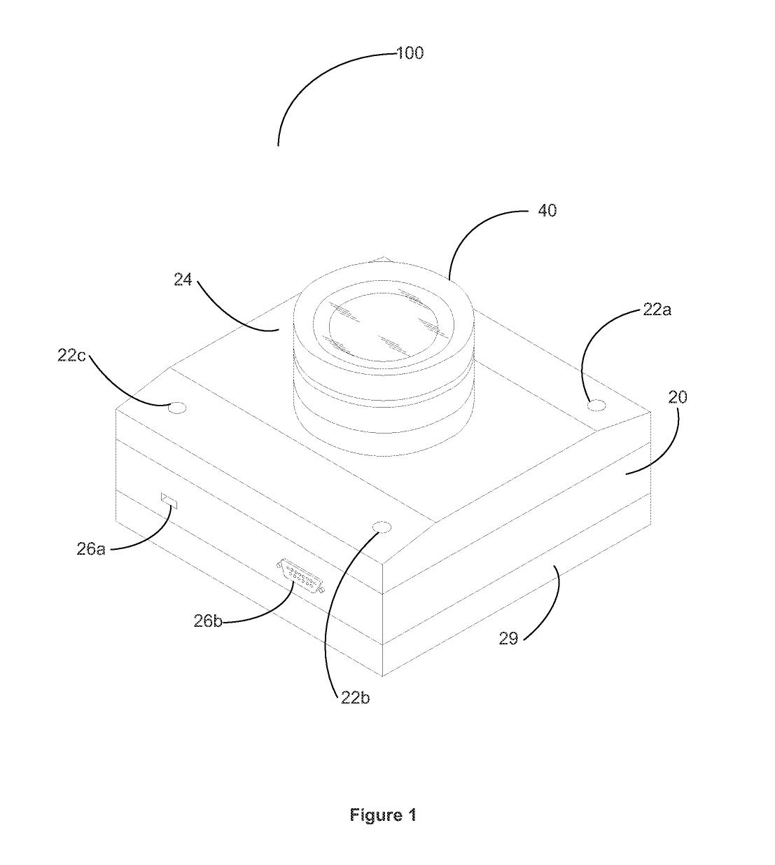

FIG. 1 illustrates the exterior of an exemplary embodiment of an astronomy camera with real time image viewing 100. Housing 20 is shown as substantially cubical, with screws 22a, 22b, 22c, 22d (not shown) securing cover 24 to housing 20. In further exemplary embodiments, housing 20 may be cylindrically shaped to mimic the dimensions of a telescope. In still further exemplary embodiments, housing 20 may a single piece. As shown in FIG. 1, housing 20 may be made of any protective material known in the art to prevent damage to a camera. In still further exemplary embodiments, housing 20 may be ruggedly reinforced to prevent damage from transportation and set up. In still further exemplary embodiments, housing 20 may include mounting structures adapted to secure astronomy camera 100 to a telescope, tripod or other structure.

Lens 40 is shown centered on top of cover 24. In further exemplary embodiments, lens 40 may be differently positioned to accommodate mounting on a telescope, tripod or other structure. In the exemplary embodiment shown in FIG. 1, lens 40 is securely attached to cover 24. In further exemplary embodiments, lens 40 may be releasably connected to cover 24 and interchangeable with other lenses known in the art. In still further exemplary embodiments, lens 40 may be interchanged with a standard camera lens and astronomy camera 100 may be used as a standard camera.

Housing 20 also contains USB port 26a and VGA output 26b. In further exemplary embodiments, housing 20 may contain more or fewer ports, inputs and outputs, and ports, inputs and outputs may be of different configurations to allow a user to couple storage or other devices with astronomy camera 100. For example, astronomy camera 100 may include SD ports, FireWire ports, A/V ports, audio ports, USB ports of different sizes, 30-pin ports, Ethernet ports, serial ports, parallel ports or any other ports or connectors known in the art that allow a user to connect astronomy camera 100 to other components which increase or enhance the functionality of astronomy camera 100. Astronomy camera 100 may also contain a power connector for powering astronomy camera 100 from an external power source.

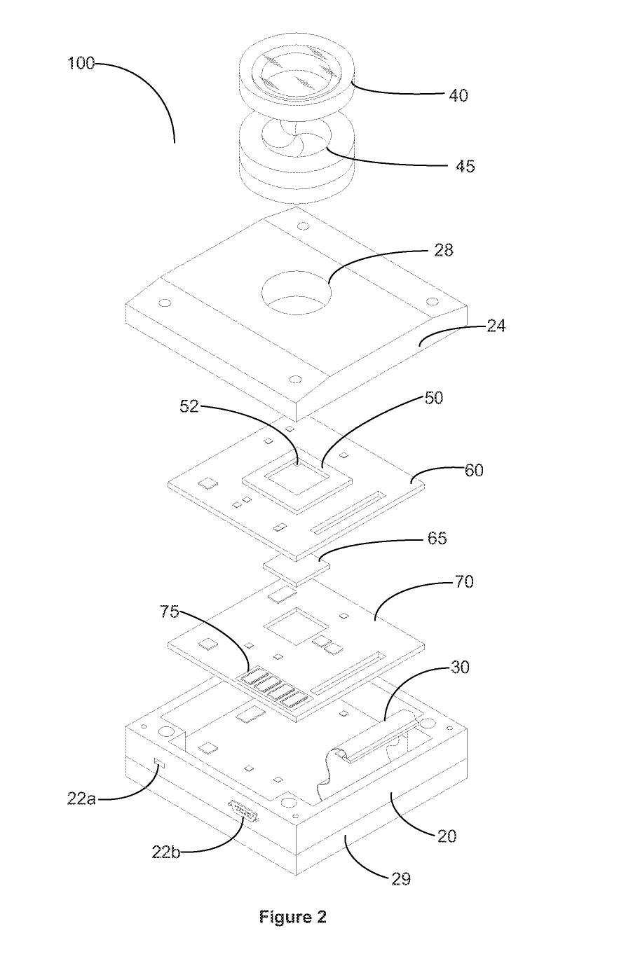

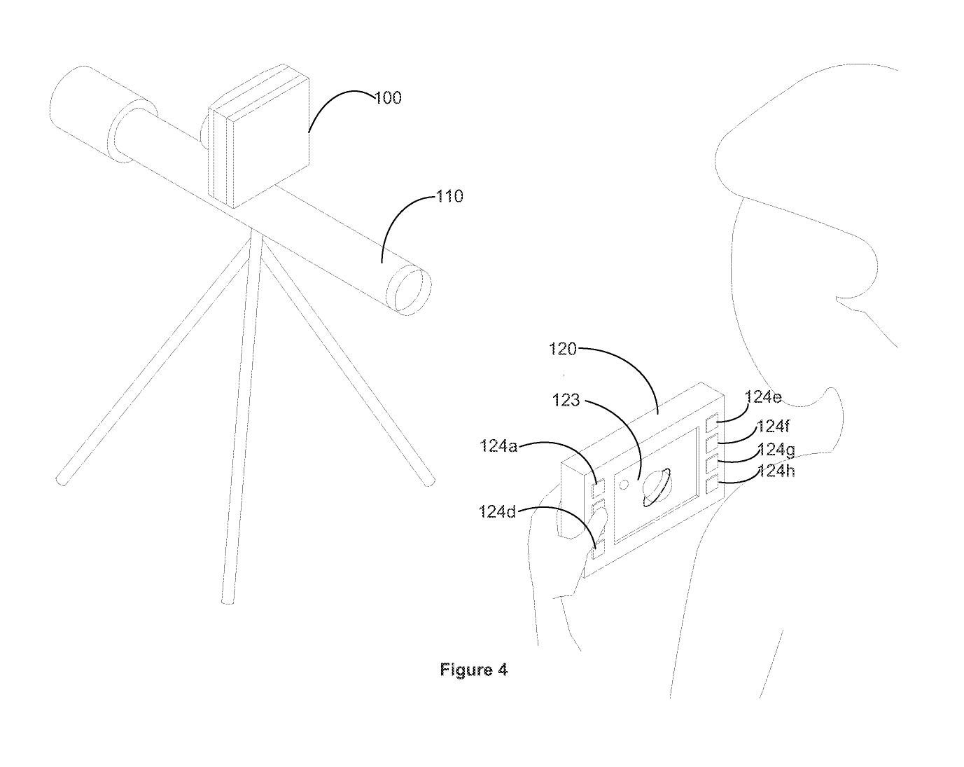

FIG. 2 is an exploded view of an exemplary embodiment of astronomy camera with real time image viewing 100. For example, in the embodiment shown, optical array detector 50 which is appropriately configured with non-destructive read capability, detects light which is converted to an analog signal. Analog/digital converter 52, directly incorporated with optical array detector 50, outputs a digital signal and sends digital data to acquisition driver 29, which in the embodiment shown is a USB acquisition driver. Acquisition driver 29 transfers the data to a processor (which may be internal or external to camera 100), which transfers the data to a user interface (which also may be internal or external to camera 100 as shown in FIGS. 4, 5, 6 and 7). In further exemplary embodiments, analog-digital converter 52 may not be directly incorporated with optical array detector 50.

While in the exemplary embodiment shown in FIG. 2, astronomy camera 100 contains a single optical array detector 50, further exemplary embodiments may include more than one optical array detector used to create a composite image. For example, a single astronomy camera 100 may contain three optical array detectors, each sensitive to a single range of color.

In the exemplary embodiment shown, shutter 45 is located behind lens 40, and lens 40 and shutter 45 may be releasably attached to cover 24 and interchangeable with other lenses and shutters known in the art. In further exemplary embodiments, lens 40 and shutter 45 may be a single component. Cover 24 contains aperture 28 which allows light to pass through lens 40 and shutter 45 to strike optical array detector 50. Optical array detector 50 senses light as it passes through lens 40, shutter 45 and aperture 28 and converts the light into a voltage or charge value. As charge accumulates, the values are periodically non-destructively read to generate an analog signal. The analog signal is converted into a digital signal to be displayed on a viewing screen. Because optical array detector 50 does not lose accumulated charge when read, it is possible to view an image in real time as astronomy camera with real time viewing is integrating the image.

In the exemplary embodiment shown, astronomy camera 100 uses a physical shutter. In still further exemplary embodiments, astronomy camera 100 may use an electronic shutter in which an electronic signal communicates with optical array detector 50 to start sensing light upon the start of exposure.

In the exemplary embodiment shown in FIG. 2, optical array detector 50 includes a color filter, allowing images captured using astronomy camera 100 to be viewed in color. In further exemplary embodiments, optical array detector 50 may not include a color filter. In still further exemplary embodiments, astronomy camera 100 may include both a sensor with a color filter and a second sensor without a color filter.

In further exemplary embodiments, astronomy camera with non-destructive read capability 100 may include an external filter or filter mounting device to allow a user to select and use filters interchangeably.

Optical array detector 50 is located on upper circuit board 60, with thermoelectric cooler 65 located immediately beneath optical array detector 50. In further exemplary embodiments, thermoelectric cooler 65 and optical array detector 50 may be positioned differently to cool optical array detector 50. Thermoelectric cooler 65 cools optical array detector 50 to minimize dark current and noise.

In the embodiment shown, upper circuit board 60 may contain detector-support circuitry, including, but not limited to, an analog-digital converter 52, bypass capacitors and other circuitry which aids in the collection of an analog signal from optical array detector 50 and conversion of the analog signal to a digital signal. In further exemplary embodiments, an analog-digital converter 52 may be directly incorporated with optical array detector 50, which in the embodiment shown is a CMOS detector with non-destructive read capability, but may include other functionally equivalent optical array detectors.

Electrical interconnect 30 transmits the converted digital data from upper circuit board 60 to lower circuit board 70, which contains internal memory 75 and other support circuitry, such as drivers to power and support USB port 22a and VGA output 22b. Because optical array detector 50 may be read without removing the accumulated charge from the sensor, images may be automatically saved or saved at a user's discretion as the image is being captured using internal memory 75 or external memory, such as a USB drive. Automatically saving images during exposure ensures that, even if an exposure is disrupted, an image captured prior to the disruption is available. Users may also be able to select and compare saved-during-exposure images having varying levels of exposure. Astronomy cameras known in the art do not use CMOS detectors with non-destructive read capability and therefore cannot save an image during exposure period, resulting in the complete loss of any image being captured if the exposure is somehow ended or disrupted.

USB port 22a and other ports, inputs or outputs may be utilized to provide external storage for images captured using astronomy camera with real time viewing 100. Internal or external memory may provide a storage location for automatically or discretionarily saved images, and even final images, after exposure is complete. Astronomy camera 100 may be further configured with circuitry allowing a user to select between internal and external storage locations for saved images and final images.

Lower circuit board 70 may also contain display drivers to power and support a display screen. Lower circuit board 70 may also be configured to communicate wirelessly with remote devices, such as computers, mobile devices and other devices able to receive a wireless signal.

Housing 20 is configured so that upper circuit board 60 and lower circuit board 70 are securely supported and fully or partially encased.

The exemplary embodiment shown in FIG. 2 contains two circuit boards. In further exemplary embodiments, astronomy camera with real time image viewing 100 may contain more or fewer circuit boards, and circuit boards may contain additional drivers to support different connections and additional memory sources. In still further exemplary embodiments, astronomy camera 100 may contain a view screen, such as an LCD screen or other viewing interface. Circuitry to support a view screen may be included on upper circuit board 60 or lower circuit board 70, or be contained on a separate designated circuit board.

In still further exemplary embodiments, astronomy camera 100 may be simplified to contain only circuits and components essential to the capturing and viewing of an image, including lens 40, shutter 45, optical array detector 50 with non-destructive read capability, thermoelectric cooler 65 and the circuitry and components necessary to power and support these components.

In further exemplary embodiments, astronomy camera with real time image viewing 100 may include an internal power supply, such as a battery or batteries or an AC or DC power supply. Batteries may be rechargeable, and housing 20 may include additional compartments for specifically enclosing and providing access to batteries or another power supply.

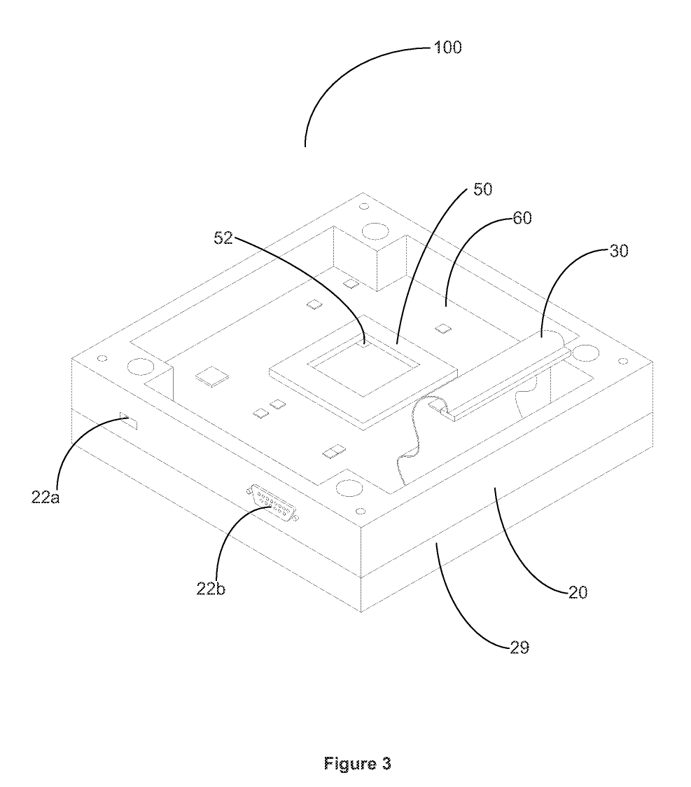

FIG. 3 illustrates an exemplary embodiment of astronomy camera with real time image viewing 100 without cover 24 (not shown). Upper circuit board 60 is exposed with optical array detector 50 with non-destructive read capability located in the center of upper circuit board 60. The central position of optical array detector 50 corresponds to the central position of lens 40 (not shown), shutter 45 (not shown) and aperture 28 (not shown) in cover 24 (not shown). Electrical interconnect 30 attaches to upper circuit board 60 and fits between upper circuit board 60 and housing 20 to connect to lower circuit board 70 (not shown). Upper circuit board 60 may also contain support circuitry, including an AD converter, bypass capacitors, and drivers to power and support USB port 22a and VGA out 22b.

In further exemplary embodiments, astronomy camera 100 may contain additional ports, inputs or outputs which may require additional circuitry. In still further exemplary embodiments, support circuitry may be entirely contained on upper circuit board 60 and no additional circuit board would be needed. In yet further exemplary embodiments, support circuitry may be divided across multiple circuit boards.

FIG. 4 is an exemplary embodiment of astronomy camera with real time image viewing 100 in use with telescope 110 and remote viewing device 120. Astronomy camera 100 is securely attached to telescope 110 with lens 40 aligned with the optical path of telescope 110. Astronomy camera 100 may be securely attached to telescope 110 through any means known in the art. In some exemplary embodiments, telescope 110 may come with camera mounting structures, or astronomy camera 100 may include camera mounting structures. Camera mounts for telescopes are known in the art, and in further exemplary embodiments, any commercially-available camera mount may be used with astronomy camera with real time image viewing 100.

In further exemplary embodiments, astronomy camera with real time viewing 100 may be securely attached to a tripod or other mounting structure adapted to stabilize and securely hold astronomy camera 100. In still further exemplary embodiments, astronomy camera 100 may include a mounting component, such as a stand or other assembly, or may be adapted to stably sit on a flat surface.

As astronomy camera with real time image viewing 100 is capturing an image, optical array detector 50 (not shown) allows the image to be read out and viewed while it is being integrated. In the exemplary embodiment shown in FIG. 4, handheld unit 120 communicates (physically or wirelessly) with astronomy camera 100 and displays the image being captured on viewing screen 123 as the image is being exposed. In further exemplary embodiments, handheld unit may communicate with astronomy camera 100 using a wired connection or any wireless connection known in the art, including, but not limited to, Wi-Fi, Bluetooth and cellular networks.

In still other embodiments all components may be integrated within housing 20, and there will be no need for external control, processing and display components.

In still other embodiments, camera 100 may be operatively coupled with an external telescope, and an integrated control may be used for both the telescope and the camera 100.

When using long exposure times to capture astronomical images, it is often desirable to track the image being viewed to prevent blur in the captured image. During a lengthy exposure, the Earth's rotation causes the sky's view to change position, and telescopes and cameras should follow the sky's position to keep a desired image in view. In the exemplary embodiment shown in FIG. 4, astronomy camera with real time viewing 100 and telescope 110 are adapted to track the image being captured by astronomy camera 100. Telescopes and telescope mounts that automatically track a view based on a starting position are known in the art. As the telescope moves to keep a particular scene in view, a camera, mounted to the telescope, also moves. It is possible, however, that a telescope or camera may track ahead or behind a desired scene. Astronomy cameras known in the art do not offer a real time view of an image as it is integrating in order to know if the desired view is being properly tracked. As a result, astronomers waste significant time, sometimes up to one hour, waiting for an image to capture that is ultimately undesirable.

In the exemplary embodiment shown, a real time view of the image being captured is displayed on viewing screen 123 as the image is exposed to allow a user to determine if telescope 110 and astronomy camera 100 are tracking properly.

In further exemplary embodiments, astronomy camera with real time viewing 100 may be configured with software to track the image being captured by comparing successive images.

Other embodiments may include software components which measure the position of object in image and update telescope control to stay on target. Such a method of control would be most effective if the selected optical array detector had non-destructive read capability and the ability to reset individual pixels.

Some telescope camera systems have two cameras. One is for astrophotography, and the other is for tracking. The latter is aimed at a bright star or object and reads out at video frame rates so that the telescope control system has enough data to stay on target. In this new application, multiple reads could be done on a single detector. The difficulty with using multiple reads for telescope control is that the brightest regions of the detector will saturate and will not be useable for telescope control. If the detector had the ability to reset pixels before they saturate, the software could command the camera to reset those pixels so that the control system would continue to have data. This method would have the added advantage of producing images with extraordinary dynamic range, since the final data would display the very brightest and most dim objects simultaneously.

Alternatively, telescope 110 and astronomy camera with real time viewing 100 may be adjusted manually or repositioned based on the image shown on viewing screen 123 using control buttons 124a-124h on handheld unit 120. Viewing screen 123 provides feedback to a user to ensure necessary positional adjustments are made as an image is integrating to result in a captured image that is both visually appealing and desirable.

In various embodiments, additional software components may be used to combine exposures to optimize a single image, isolate exposures or analyze specific elements of exposures for quality and clarity. Still further embodiments may automatically analyze, adjust, store and discard images.

In further exemplary embodiments, control buttons 124a-124h may be differently configured to provide a user with control of telescope 110 and astronomy camera with real time viewing 100. For example, in the exemplary embodiment shown, control buttons 124a-124h are shown as square push buttons. However, in further exemplary embodiments, handheld unit 120 may be configured with a joystick, directional pad, touch screen or any other device, structure or combination thereof to allow a user to adjust the alignment and positioning of telescope 110 and astronomy camera 100. In yet further exemplary embodiments, handheld unit 10 may not be configured to remotely adjust the positioning of telescope 110 and astronomy camera 100.

In the exemplary embodiment shown in FIG. 4, handheld unit 120 is shown as a rectangular controller. In further exemplary embodiments, handheld unit 120 may any device adapted to receive information from astronomy camera with real time viewing 100 and display an image as it is being integrated on a viewing screen. For example, in further exemplary embodiments, handheld unit 120 may be a television, computer, monitor or any other device with a visual display. In still further exemplary embodiments, viewing screen 123 and control buttons 124a-124h may be located directly on astronomy camera with real time viewing 100.

Control buttons 124a-124h may also be used to control different functions of astronomy camera with real time viewing 100, including, but not limited to, setting exposure times, ending exposure times, setting time or date information, selecting a location and format to save a captured image, setting auto-save functions, and turning a display screen on and off.

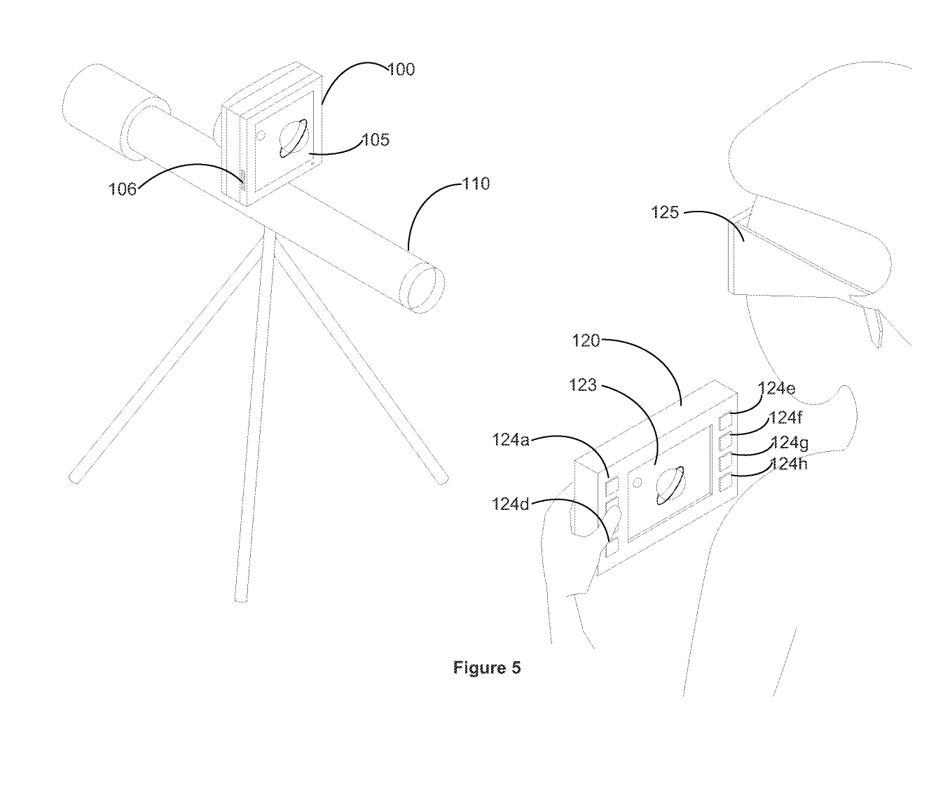

FIG. 5 illustrates an exemplary astronomy camera with real time viewing 100 in use with viewing glasses 125 (e.g., video glasses or video eyewear which are known in the art for applications other than astronomy). Astronomy camera with real time viewing 100 is mounted to telescope 110. In the exemplary embodiment shown, astronomy camera 100 contains viewing screen 105 adapted to display a real time view of the image being captured as it is being exposed. Astronomy camera 100 is also shown with control button panel 106 which may be used to choose a saving format or location, turn viewing screen 105 on and off or change other astronomy camera 100 settings.

Handheld unit 120 is adapted to communicate wirelessly with astronomy camera 100. Handheld unit 120 may also be used to control or change setting of astronomy camera 100.

In still further exemplary embodiments, astronomy camera with real time viewing 100 may be configured with software adapted to communicate with an internet-based program or database that identifies stars, constellations or other astronomical bodies by utilizing location, positional, date and time information from astronomy camera 100, handheld unit 120 or viewing glasses 125 or entered by a user and comparing the scene being viewed with known astronomical charts. Viewing screens 105 and 123 and viewing glasses 125 may then be configured with software to display the identification of stars, constellations or other astrological bodies over the images being viewed.

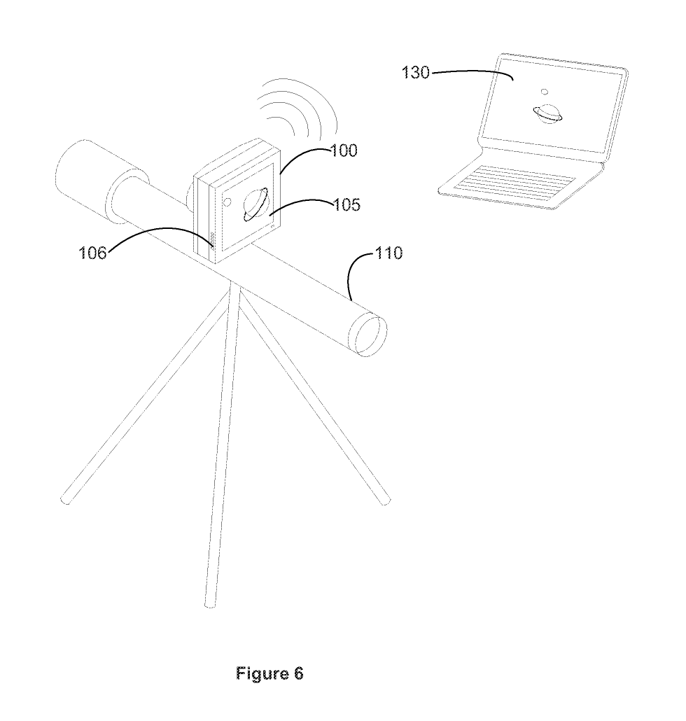

FIG. 6 is an exemplary embodiment of astronomy camera with real time viewing 100 adapted to be controlled and viewed remotely by computer 130 over a wide area network or in disparate geographical locations. In the exemplary embodiment shown, astronomy camera 100 is securely connected to telescope 110. Astronomy camera 100 is adapted to communicate wirelessly with computer 130, which may be located in a remote location. During inclement weather, users may therefore stay indoors and still be able to view images from astronomy camera 100 as they are being integrated. Computer 130 may also be utilized to control the position and other features of astronomy camera 100.

For example, astronomy camera with real time viewing 100 may act as a web-cam. Astronomy camera 100 may be configured with software that allows astronomy camera 100 to broadcast images viewed through telescope 110, whether the image is being integrated or not, to a specific online user account. Users and others with login information for the account may then view images seen through telescope 110 and astronomy camera 100. Anyone logged into an account corresponding to astronomy camera 100 may also be also be able to view images in real time as they are being integrated prior to final capture.

In still further exemplary embodiments, astronomy camera with real time viewing 100 may also come with a software packet to be installed on computer 130 that allows a user to edit images captured with astronomy camera 100. Images may be wirelessly transmitted to computer 130 or physically transferred to computer 130 through a wired connection or by connecting computer 130 to an external storage device used to store images from astronomy camera 100. Using the software provided with astronomy camera 100, a user may crop, enhance or otherwise edit images. A user may also use the provided software to capture and edit images during an exposure.

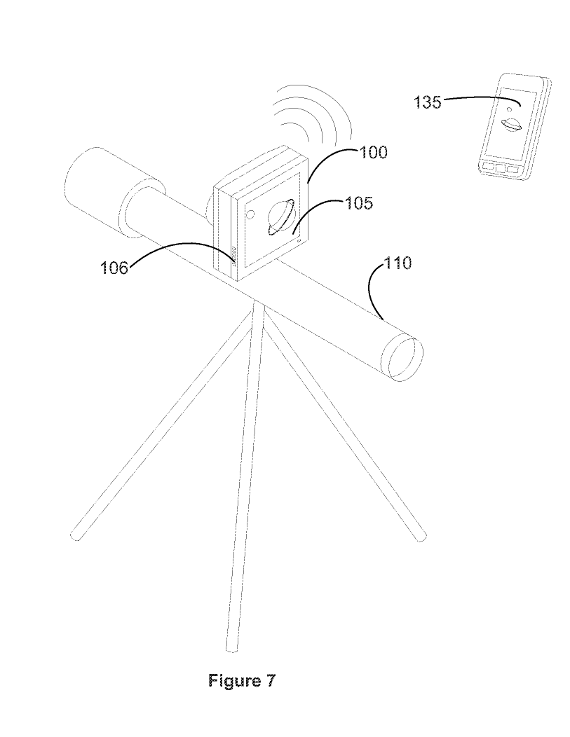

FIG. 7 illustrates an exemplary embodiment of astronomy camera with real time viewing 100 in wireless communication with mobile device 135. In the exemplary embodiment shown, astronomy camera 100 is adapted to communicate wirelessly with mobile device 135. Astronomy camera 100 may be configured with a unique identification number or signal which allows only specified users to be able to access astronomy camera 100 remotely using mobile device 135.

In the exemplary embodiment shown, mobile device 135 is illustrated as a smartphone, although mobile device 135 may be any device known in the art to receive a wireless signal from astronomy camera 100.

In further exemplary embodiments, users may be able to sync astronomy camera with real time viewing 100 with a remote-viewing application, or app, configured specifically for smartphones and other mobile devices. Through a remote-viewing app, users will be able to view and share images as they are being integrated and monitor the scene being captured by astronomy camera 100.

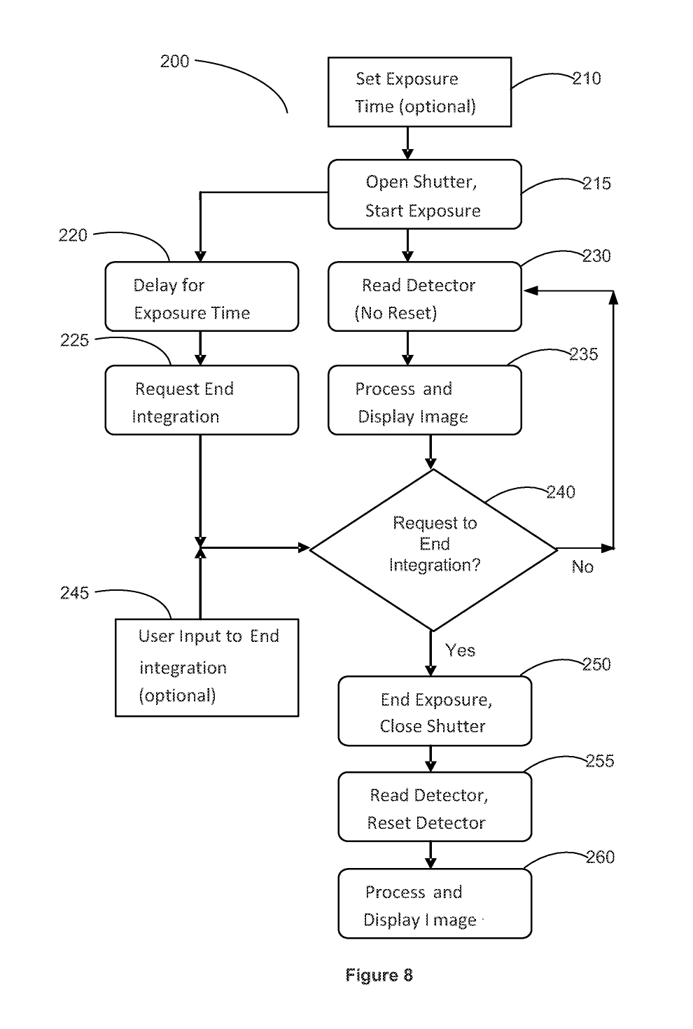

FIG. 8 is a flowchart illustrating the processing steps 200 used by astronomy camera with real time viewing 100. In step 210, an exposure time is optionally set. Current astronomy cameras known in the art require an exposure time to be set, and an image will not be captured until the end of that set exposure time as a result of using CCD detectors or CMOS detectors with destructive read. Ending an exposure before a set time, therefore, results in the complete loss of the image. Because astronomy camera with real time viewing 100 (not shown) uses optical array detector 50 (not shown), exposures may be ended at any time while the charges accumulated on optical array detector 50 (not shown) are being read out. Setting an exposure time for astronomy camera with real time viewing 100 (not shown), therefore, is optional.

In step 215 exposure begins. Current astronomy cameras known in the art, which utilize CCD or CMOS detectors with destructive read, then proceed to delay for the exposure time, as indicated in step 220, and proceed to follow the steps illustrated along the left-most process branch. Once the exposure time has ended in step 225, the exposure is ended (step 250), the detector is read and therefore reset (step 255) and an image is ready to be displayed (step 260). These steps are also followed by astronomy camera with real time viewing 100 (not shown), with the additional steps of reading the detector and allowing user feedback to end an exposure at any time.

While astronomy camera with real time viewing 100 (not shown) is delaying for the exposure time in step 220, optical array detector 50 (not shown) is simultaneously being read out in step 230. Because charges accumulated on light sensing elements in non-destructive optical array detector 50 (not shown), which in the embodiment described is a CMOS detector, are non-destructively read, there is no reset when charges are read out, and charges from optical array detector 50 (not shown) can be processed and an image displayed in step 235.

Because the image being captured is displayed as it is integrated (step 235), a user comes to deciding point 240. A user may choose to end the exposure (step 245) based on input from the image being displayed in step 235, in which case the exposure is stopped in step 250. In step 255, the detector is read for the final time and reset, and the final image is processed and displayed (step 260).

A user may also opt to not end the exposure based on the image being displayed in step 235. The process then repeats steps 230 and 235 to continue displaying the image as it is being exposed until either the user requests to end exposure (step 245) or a pre-set exposure time lapses (step 225).

Astronomy cameras existing in the art, which use CCD or CMOS detectors with destructive read, do not allow for the repetition of steps 230 and 235 as an image is being exposed, thereby removing a user's ability to optionally end exposed based on input from an image displayed in step 235.

What is claimed is:

1. A camera apparatus for displaying sampled astronomical images in real time comprised of:
a camera housing with an aperture;
at least one optical focusing element positioned in the optical path of said aperture on the exterior of said housing.
at least one optical array detector configured to non-destructively read data comprised of an array of non-destructive read light sensitive elements, said non-destructive read light sensitive elements comprised of a light sensitive component and buffer component, wherein said light sensing elements are capable of reading acquired photocharge in a non-destructive manner and without resetting;
at least one image data processor configured to display and update consecutively acquired astronomical images on at least one user interface in real time; and
an analog-digital converter operatively coupled to each of said non-destructive read light sensitive elements and capable of transmitting a digital representation of the data collected by said array of non-destructive read light sensitive elements to said at least one image data processor.

2. The apparatus of claim 1 wherein a plurality of said at least one optical array detectors are arranged in close proximity to form a composite image.

3. The apparatus of claim 1 which further includes at least one filter mounting device.

4. The apparatus of claim 1 wherein said at least one image data processor is external to said camera housing.

5. The apparatus of claim 1 wherein said user interface is external to said camera housing.

6. The apparatus of claim 1 which further includes a shutter aligned between said optical focusing element and said array of non-destructive read light sensitive elements.

7. The apparatus of claim 1 which further includes a thermoelectric cooler positioned proximately to said array of non-destructive read light sensitive elements.

8. The apparatus of claim 1 wherein said buffer component is a MOSFET component.

9. The apparatus of claim 1 wherein said optical array detector is a CMOS detector configured with non-destructive read capability.

10. The apparatus of claim 1 which is operatively coupled to a telescope using a telescope mounting structure.

11. The apparatus of claim 1 wherein said non-destructive read light sensitive elements are photodiodes coupled with a MOSFET component.

12. The apparatus of claim 1 which further includes an internal memory component adapted to store said digital representation.

13. The apparatus of claim 1 which further includes an image processing hardware component further configured with image processing software.

14. The apparatus of claim 13 wherein said image processing hardware component is further configured with software to locate and identify astronomical images captured by said optical array detector and display said identifications on said user interface with said digital representation.

15. A system for displaying sampled astronomical images in real time comprised of:
an astronomy camera with non-destructive read capability comprised of:
a housing with an aperture,
an optical focusing element positioned in the optical path of said aperture on the exterior of said housing,
a CMOS detector positioned in the optical path of said optical focusing element and said aperture inside said housing comprised of an array of non-destructive read light sensitive elements, said non-destructive read light sensitive elements comprised of a light sensitive component and buffer component, wherein said light sensitive elements are capable of reading acquired photocharge in a non-destructive manner and without resetting, and
at least one image data processor configured to display and update consecutively acquired astronomical images on at least one user interface in real time, and
an analog-digital converter operatively coupled to each of said non-destructive read light sensitive elements and capable of transmitting a digital representation of data collected by said array of non-destructive read light sensitive elements to said image data processor and transmitting updated digital representations of updated data collected by said array of non-destructive read light sensing elements,
at least one user interface configured to receive and display said digital representation from said image data processor and dynamically update to display said updated digital representations;
a means for a user to optionally start and end exposure based said updated digital representations.

16. The system of claim 15 wherein said at least one user interface is selected from a group consisting of a viewing screen integrated with said housing, a remote viewing screen, a computer, a laptop, a mobile device, viewing glasses, a television and combinations thereof.

17. The system of claim 15 which is further integrated with post-processing software to edit and overlap said digital representation and said updated digital representations.

18. A method of using a camera system with non-destructive read capability to capture an astronomical image comprised of the steps of:
starting image exposure;
reading an initial image from an optical array detector;
displaying said initial image from said optical array detector;
reading subsequent images without image reset during exposure;
displaying said subsequent images; and
providing a user with the means of ending said exposure upon reviewing said displayed images.

19. The method according to claim 18 which further includes the steps of saving said initial image and said subsequent images.

20. The method according to claim 18 wherein the steps of reading subsequent images without image resent during exposure and displaying said subsequent images are repeated until said user ends said exposure.
